(19) United States
(12) Patent Application Publication
(10) Pub. No.: US 2020/0196646 A1
(43) Pub. Date: Jun. 25, 2020

(54) METHOD AND SYSTEM FOR MANUFACTURING A COOKED EGG PRODUCT

(71) Applicants: Oliver D. Gildersleeve, III, Cambridge City, IN (US); Scott R. VanDevanter, Kettering, OH (US)

(72) Inventors: Oliver D. Gildersleeve, III, Cambridge City, IN (US); Scott R. VanDevanter, Kettering, OH (US)

(73) Assignee: Sugar Creek Packing Co., Washington Court House, OH (US)

(21) Appl. No.: 16/722,431

(22) Filed: Dec. 20, 2019

Related U.S. Application Data
(60) Provisional application No. 62/782,743, filed on Dec. 20, 2018.

(51) Int. Cl. A23L 15/00; A47J 29/02; A23B 5/04; A23B 5/005; A47J 29/06; A47J 37/04

(52) U.S. Cl. CPC A23L 15/00; A47J 29/02; A23B 5/043; A23B 5/0057; A23V 2300/24; A47J 37/044; A23V 2002/00; A23V 2300/20; A47J 29/06

(57) ABSTRACT

A system and method for manufacturing a cooked egg product includes an automated egg cracker that receives the raw, shelled eggs from the infeed conveyor and removes the shells from the eggs; a cooking conveyor having a plurality of cooking pans that receives the whole eggs and induction heats the cooking pans sufficiently to completely cook the eggs contained in the cooking pans, resulting in cooked eggs; a pasteurization tunnel that receives the cooked eggs in the cooking pans from the induction heater; and a control that actuates the pasteurization tunnel to heat the surfaces of the eggs to a pasteurization temperature. A freezer freezes the cooked and pasteurized eggs, and a packaging machine packages the frozen, cooked and pasteurized eggs. Alternatively, the induction cooked eggs are frozen after cooking and individually vacuum packaged, sous vide heated to a pasteurization temperature, then chilled or frozen for storage or shipment.

### TECHNICAL FIELD

The present disclosure relates to methods and systems for preparing food products on a commercial scale, and more particularly, to methods and systems for preparing a ready-to-eat, fully cooked, pasteurized egg product that may take the form of a fried egg, sous vide egg bites, and egg mixtures such as frittatas and omelets.

### BACKGROUND

Eggs are a common staple of the menu of restaurants that serve breakfast and brunch, and some restaurants serve egg dishes throughout the day. A popular egg dish is a single egg cooked “sunny side up,” in which a whole egg is fried on just one side and not flipped. The yolk is intact, preferably circular in shape, and is largely or completely liquid within a thin membrane. The intact yolk is surrounded by the egg white, which is solid but frequently is barely set. For restaurants such as fast food or quick serve restaurants, there is a need to prepare dishes that consist of or include sunny side up eggs quickly.

Typically, fried eggs are cooked by cracking whole shell eggs, depositing these whole cracked eggs in a cooking pan with oil, grease, or animal fat, and cooking the egg by way of convection or induction, finishing at a minimum safe temperature of 143° F. in the core and surface of the yolk for a minimum 6 minutes. Variations of fried egg include sunny side up, characterized by a soft yolk, yellowish orange yolk color, and cooked to a 143° F. (62° C.) soft yolk core; over easy, characterized by a white colored top and bottom with soft yolk (143° F. (62° C.) core); and over hard, characterized by a white top and bottom with a hard yolk (155° F. (68° C.) or greater core).

Homogenized egg mixtures utilize liquid eggs, egg whites, egg yolks, or both, often mixed with various inclusions, such as ready-to-eat vegetables, ready-to-eat meats, cheeses, or combinations of the foregoing. Such egg mixtures can be deposited into molds, pans, or other carriers, and processed. Processing may involve following the same process as frying an egg by way of carrier pan and cooking for a “fried” effect. Alternatively, egg mixtures may be vacuum sealed and processed utilizing precision water bath cooking or precision induction and convection cooking.

Fast food restaurants typically employ comparatively low skilled cooks and other food preparers who must contend with cracking whole eggs, frying them on a skillet or hot plate in a manner and for a time selected for maximizing the organoleptic properties of the fried eggs, and at the same time maintaining proper hygienic standards for storing, handling, and preparing such fried egg dishes. Such egg frying processes generate waste in the form of egg shells, broken eggs, and spent oil, all of which must be disposed of.

Accordingly, there is a need for a method and system for preparing sunny side up eggs, as well as other fried egg dishes such as omelets and frittatas, in commercial quantities in a manner that ensures proper pasteurization. Current methods and systems can produce cooked eggs in commercial quantities, but do not provide a practical way to fry eggs and provide pasteurization without overcooking. There also is a need for a method and system that includes packaging of the cooked egg product that optimizes storage of the cooked and packaged egg product.

### SUMMARY

The disclosed system and method provide fully cooked and packaged egg products that can be produced in commercial quantities in a controlled environment and stored or shipped to end users for reheating and consumption. The end user of the egg products need only reheat the packaged egg product, such as by microwaving or sous vide cooking, to provide a ready-to-eat egg dish having the organoleptic properties of freshly cooked eggs. The disclosed system and method provide egg dishes, including the popular sunny side up egg, that is visually as well as organoleptically pleasing, while providing proper pasteurization without overcooking. This is especially important in cooking sunny side up eggs, in which the underside of each egg is fried, but the yolk remains largely or entirely liquid.

In an embodiment, a system for manufacturing a cooked egg product includes an automated egg cracker that receives the raw, shelled eggs from the infeed conveyor and removing the shells eggs from the eggs; a cooking conveyor having a plurality of cooking pans that receives the whole eggs from the automated egg cracker; an induction heater that heats the cooking pans sufficiently to completely cook the eggs contained in the cooking pans, resulting in cooked eggs; a pasteurization tunnel that receives the cooked eggs in the cooking pans from the induction heater; and a control that actuates the pasteurization tunnel to heat the upper surfaces of the cooked eggs to a pasteurization temperature, resulting in a cooked egg product of pasteurized cooked eggs. A freezer unit receives the pasteurized cooked eggs from the pasteurization tunnel and freezes them, resulting in frozen pasteurized cooked eggs, and a packaging machine packages the frozen pasteurized cooked eggs.

In another embodiment, a system for manufacturing a cooked egg product, in particular sunny side up eggs, includes a cooking conveyor having a plurality of cooking pans; an egg cracking machine that deposits raw whole eggs individually onto each of the plurality of cooking pans; an induction heater that heats the cooking pans sufficiently to fry the raw whole eggs contained in the cooking pans to make sunny side up cooked eggs; a freezer that receives the sunny side up cooked eggs from the induction heater and freezes the sunny side up cooked eggs, resulting in frozen sunny side up cooked eggs; and a packaging machine receives the frozen sunny side up cooked eggs and vacuum seals the frozen sunny side up cooked eggs in pouches. A heating chamber receives the pouches of frozen sunny side up cooked eggs and sous vide heats the frozen sunny side up cooked eggs for a time and temperature selected to pasteurize the upper surfaces of the sunny side up cooked eggs but below a temperature at which the yolks of the cooked sunny side up eggs solidify, resulting in pasteurized sunny side up cooked eggs in the pouches; and a cooler that chills or freezes the pasteurized cooked sunny side up eggs in the pouches.

In yet another embodiment, a method for manufacturing a cooked egg product includes placing raw, shelled eggs on an infeed conveyor in a raw area; receiving the raw, shelled eggs from the infeed conveyor and removing the shells from the eggs by an automatic egg cracker, resulting in liquid whole eggs; receiving the liquid whole eggs from the automatic egg cracker and placing the liquid whole eggs on a plurality of cooking pans on a cooking conveyor that receives the liquid whole eggs from the automatic egg cracker; induction heating the cooking pans sufficiently to cook the liquid whole eggs contained in the plurality of cooking pans, resulting in cooked eggs; and receiving the cooking pans containing the cooked eggs in a pasteurization tunnel and pasteurizing the cooked eggs. The pasteurized cooked eggs are received in a freezer in a ready-to-eat area. The frozen pasteurize cooked eggs are then packaged.

In still another embodiment, a method for manufacturing a cooked egg product, in particular sunny side up eggs, includes depositing raw whole eggs individually onto each of a plurality of cooking pans; induction heating the cooking pans sufficiently to fry the raw whole eggs contained in the cooking pans to make sunny side up cooked eggs; and freezing the sunny side up cooked eggs in the cooking pans, resulting in frozen sunny side up cooked eggs. The frozen sunny side up cooked eggs are then vacuum sealed in pouches, and the pouches of frozen sunny side up cooked eggs are sous vide heated for a time and temperature selected to pasteurize the upper surfaces of the sunny side up cooked eggs but below a temperature at which the yolks of the cooked sunny side up eggs solidify, resulting in pasteurized sunny side up cooked eggs in the pouches. The pasteurized cooked sunny side up eggs are chilled or frozen in the pouches.

Other objects and advantages of the disclosed system and method for manufacturing a cooked egg product will be apparent from the following description, the accompanying drawings, and the appended claims.

### BRIEF DESCRIPTION OF THE DRAWINGS

FIG. 1 is a schematic, perspective view of an embodiment of the disclosed system for manufacturing a cooked egg product;

FIG. 1A is a perspective view of a carton of eggs in shell used by the disclosed system for the disclosed process;

FIG. 1B is a perspective view of a detail of an embodiment of the disclosed system showing an egg cracking machine, the cooking pan conveyor and induction heating coils;

FIG. 2 is a detail perspective view of the system of FIG. 1, showing the infeed conveyor, automatic egg cracking machine, cooking conveyor, induction heater, and optional sprayer;

FIG. 3 is a schematic showing the embodiment of FIG. 1;

FIG. 4 is a schematic showing another embodiment of the disclosed system for manufacturing a cooked egg product; and

FIG. 5 is a perspective view of sunny side up cooked eggs sealed in pouches and made by the disclosed methods and systems of FIG. 1 and FIG. 4.

### DETAILED DESCRIPTION

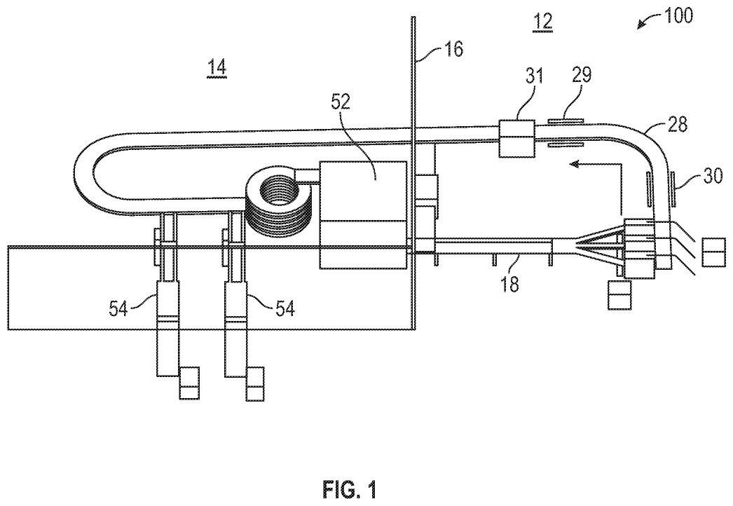

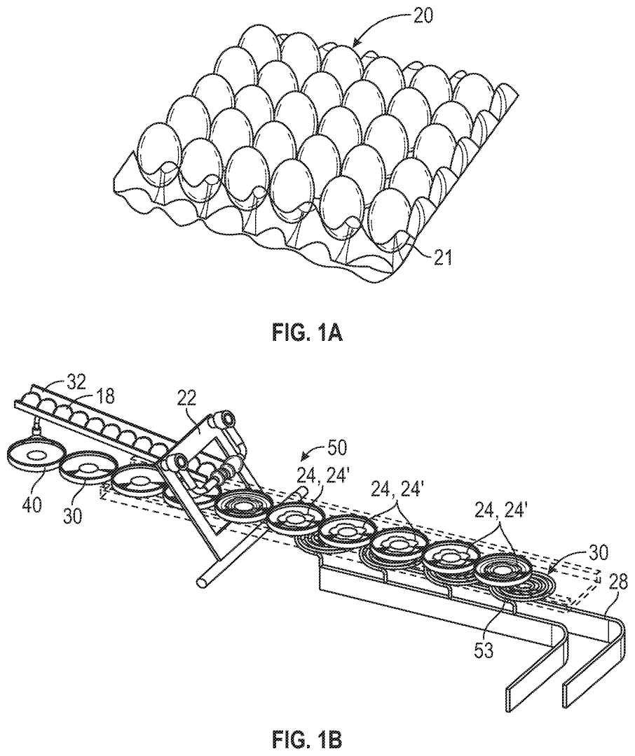

As shown in FIGS. 1, 1A, 1B, 2, and 3, an embodiment of the disclosed system for manufacturing a cooked egg product, generally designated 100, includes a raw area 12, where raw, whole eggs, typically chicken eggs, are received in-shell, the shells cracked and discarded, and the eggs are fried or otherwise cooked and pasteurized to form the cooked egg product; and a ready-to-eat area 14, where the fried and pasteurized eggs are frozen, packaged, and stored frozen (e.g., less than 10° F. (−12° C.)) or chilled (e.g., between 15° F. and 30° F. (−9 and −1° C.)). The raw area 12 is isolated from the ready-to-eat area 14 by a separation wall 16. In embodiments, the raw area 12 is an environmentally isolated room that is kept at 40° F. (4.4° C.) or lower, and the ready-to-eat area 14 is an environmentally isolated room that also is kept a 40° F. or lower. In embodiments, such environmentally isolated rooms receive filtered air from the ambient, have hermetically sealed windows and air-locked doors, and are maintained at a positive air pressure relative to ambient to prevent ingress of contaminants.

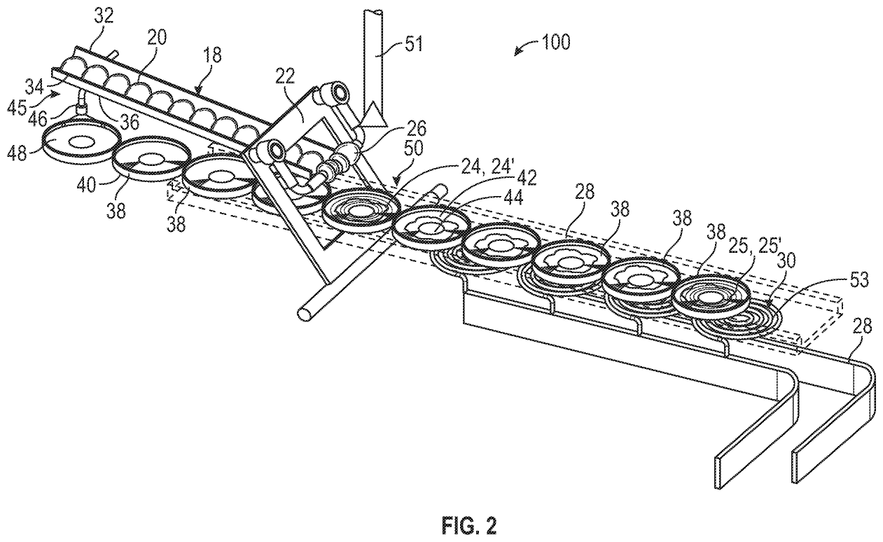

The raw area 12 includes an infeed conveyor 18 that receives shelled (i.e., in shell) raw whole eggs 20, which may be delivered in trays 21 (FIG. 1A), an automatic egg cracking machine 22 that receives the shelled eggs from the infeed conveyor, then cracks and removes the shells 26, leaving a liquid egg product, which may take the form of liquid whole eggs 24 (i.e., egg white and intact egg yolk of a single egg), a cooking conveyor 28 that receives the liquid eggs from the automatic egg cracking machine, an induction heater 30 (see FIGS. 1B and 2) that fries or otherwise cooks the liquid eggs on the conveyor to form a cooked egg product that may take the form of a fried or otherwise cooked egg 25, and a pasteurization tunnel 29 that maintains the heat of at least the surfaces of the fried or otherwise cooked eggs 25 for a time and temperature selected to pasteurize at least the surfaces of the fried or otherwise cooked eggs. In an embodiment, the eggs 20 are graded and inspected prior to delivery, so that only Grade A or better eggs 20 are used. In an embodiment, the raw area 12 includes a loading area 17, where egg crates or trays 21 are loaded onto the infeed conveyor 18.

In an alternative embodiment of the system 100, the system utilizes a liquid egg product that may take the form of whole or separated pasteurized homogenized egg mixtures 24′ (egg whites and/or egg yolks). The egg mixture 24′ is brought into the raw area 12 in totes or tankers 55 and mixed on-site in blenders 57. The egg mixture 24′optionally contains inclusions selected from cheeses, animal proteins (e.g., bacon bits), ready-to-eat and clean individually quick frozen (IQF) vegetables, spices, and combinations of the foregoing. Alternatively, the egg mixtures 24′ are vacuum-sealed to the extent that they are processed utilizing precision water bath cooking, or precision induction and convection cooking.

In the embodiment of the system 100 in which whole eggs 20 are utilized, as shown best in FIG. 2, the infeed conveyor 18 includes opposing side walls 32, 34 and a base 36 spaced to allow single shelled raw whole eggs 20 to move seriatim to the automatic egg cracking machine 22. In embodiments, the whole eggs 20 may be graded and inspected prior to delivery, removed from the trays 21, and loaded onto the infeed conveyor 18, which arranges the raw whole eggs 20 in a lane or multiple lanes. In embodiments, the system 100 includes multiple conveyors of shelled raw whole eggs 20, and multiple automatic egg cracking machines 22, or alternatively, automatic egg cracking machines that accommodate eggs input from multiple conveyors 18 to perform egg cracking of multiple eggs simultaneously.

The cooking conveyor 28 includes a line of connected cooking pans 38, which in embodiments are arranged on an endless belt, such as a flexible belt, or are connected by chain links to form an endless conveyor. In embodiments, the cooking conveyor 28 also includes a washer 31 that receives the cooking pans 38 on their return leg underneath the conveyor and washes and sterilizes each of the cooking pans.

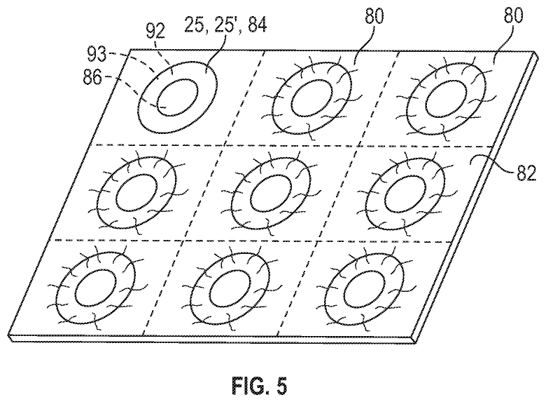

In embodiments, each cooking pan 38 includes a circular peripheral wall 40 and a bottom wall 42, which in embodiments is concave and having a flat, disc-shaped center 44. In embodiments, the cooking pans 38 are made of stainless steel or other ferromagnetic material suitable for induction heating and have a diameter large enough to accept a single liquid egg 24. The center 44 of the bottom wall 42 is approximately the diameter of a single egg yolk 86 (FIG. 5) or slightly larger. In embodiments, the bottom walls 42 of the cooking pans 38 are concave or are conical to center the liquid egg 24 on the cooking pan so that the yolk of the liquid egg, which in embodiments is unbroken, is centered over the center 44.

In embodiments, the cooking conveyor 28 includes a spraying station 45, with a sprayer 46 that sprays a non-stick lubricant/release agent, such as cooking oil 48, which may be selected to add flavor to the cooked egg 25, onto at least the upper surfaces of the bottom walls 42 of the cooking pans 38. In embodiments, the spraying station is positioned upstream of the location 50 on the conveyor 18 where liquid eggs 24 are deposited onto the cooking pans 38, so that the liquid eggs are deposited and subsequently fried or otherwise cooked on lubricated cooking pans.

In embodiments in which the liquid egg product in the form of the homogenized egg mixtures 24′ is used, measured quantities of the egg mixture are deposited onto the cooking pans 38 through a conduit 51 at location 50. The egg mixtures 24′ are deposited in discrete quantities sufficient to cover the bottom walls 42 of the cooking pans 38. In this embodiment, the cooking pans 38 optionally are first coated with a cooking oil 48 from the sprayer 46 at the spraying station 45.

In embodiments, the induction heater 30 includes a plurality of induction coils 53, or alternatively, a single coil or a single elongate induction coil, that is energized by a power source (not shown). The induction coils 53 induction heat the cooking pans 38, which in turn heat the cooking oil 48 and fry or otherwise cook the eggs 24 and/or egg mixtures 24′ in the cooking pans. In embodiments, the cooking conveyor 28 and cooking pans 38 carrying liquid eggs 24 or egg mixtures 24′ move continuously over the induction heater 30 at a rate so that the automatic egg cracking machine 22 operates continuously. In other embodiments, operation of the automatic egg cracking machine 22 and induction heater 30 is sequential or operates in batch mode.

The induction heater 30 is selected to be sufficiently long, and the induction frequency is matched to the material, such as certain stainless steels, cast iron, or ferrous metal containing material, and thickness of the cooking pans 38 so that the liquid eggs 24 are fried, in embodiments in the cooking oil 48, to a core temperature of the yolk 86 and white 93 (FIG. 5) of at least 143° F. (62° C.), alternatively to a temperature of the egg white of 140° F. (60° C.), by the time the cooking pans containing the eggs traverse the length of the induction heater 30 for a sunny side up cooked egg 25. Variations of cook time and temperature lead to appearance of the whole egg 24 taking the form of a sunny side up, over easy, or poached appearance, and product specification may include browning (Maillard reaction) on part of whole of egg bottom or edge. In still other embodiments, the egg mixtures 24′ are cooked to a preselected core temperature, such as 143° F. (62° C.).

In embodiments, the frying or otherwise cooking of the liquid eggs 24 or egg mixtures 24′ in the cooking oil 48 in the cooking pans 38 may continue after the cooking pans have passed beyond a position over the induction coils 53 of the induction heater 30 and no longer receive electromagnetic energy from the induction coils, in which case the cooking pans cool at a defined rate based on mass of the pan and environmental conditions. In other embodiments, cooking of the liquid eggs 24 or egg mixtures 24′ is substantially completed while the cooking pans 38 are still positioned over the induction coils 53 so that they are receiving electromagnetic energy from the induction coils and therefore are heated to a cooking or frying temperature. In embodiments where browning of the fried or otherwise cooked eggs 24 is not required, less power will be applied to the cooking pans 38 to prevent browning as product specifications require.

After the cooking or frying of the eggs 24 or egg mixtures 24′ to form egg products in the form of fried or cooked eggs 25 or cooked egg mixtures 25′ is completed, the cooking conveyor 28 transports the cooking pans 38 containing fried or otherwise cooked eggs 25 or cooked egg mixtures 25′ to the pasteurization tunnel 29 (see FIG. 1). By the time the cooking pans 38 enter the pasteurization tunnel 29, the egg whites of the fried or otherwise cooked eggs 25 or egg mixtures 25′ have set up, Maillard reaction has or will be occurring on the contact surface of the eggs to the cooking pans 38.

In embodiments, the pasteurization tunnel 29 is sufficiently wide to accommodate a cooking conveyor 28 having multiple lanes of cooking pans 38 and is sufficiently long to provide residence times from 4 minutes to 10 minutes, or longer if required, as the cooking conveyor 28 continuously moves the cooking pans 38 through the conveyor. In embodiments, the pasteurization tunnel 29 is insulated or jacketed and to maintain side wall temperatures sufficient to reduce or eliminate all condensation effects inside the pasteurization tunnel. In embodiments, the pasteurization tunnel 29 is heated by a heating unit 35, which in embodiments is selected from electric coils, steam coils, gas flame, and infrared (e.g., quartz) coils, directly and/or by convection, and/or direct steam injection in a pan 37, in embodiments with or without water, and in other embodiments an oil bath, below the cooking conveyor 28, that maintains the wet bulb temperature within the tunnel to between 130° F.-200° F. (54° C.-93° C.), and in other embodiments 135° F.-200° F. (57° C.-93° C.), as needed for pasteurizing the upper surfaces 92 (FIG. 5) of the fried or cooked eggs 25 or egg mixtures 25′. In other embodiments, the pasteurization tunnel 29 also finishes cooking the cooked egg 25 or cooked egg mixtures 25′ to meet product look, taste, and product specifications, which specifications in embodiments are set by the customer. In still other embodiments, the pasteurization tunnel 29 is actuated to maintain a wet bulb temperature within the pasteurization tunnel to between 130° F.-200° F. (54° C.-93° C.), and in other embodiments 135° F.-200° F., to finish cooking the egg product, which includes liquid eggs 24 or liquid egg mixtures 24′, in the cooking pans 38. In an embodiment, a control 110 actuates the heating unit 35 in the pasteurization tunnel 29 to finish cooking, and/or brown the upper surfaces 92 (FIG. 5) of cooked egg mixtures 25′ in the form of frittatas.

In other embodiments of the system 100, the pasteurization tunnel 29 is operated by the control 110 to heat the cooked eggs 25, which at this point are fried eggs, until the upper surfaces 92 of the eggs turn white with a soft yolk (143° F. (62° C.) core temperature) for over easy fried eggs; and over hard fried eggs, characterized by a white top and bottom with a hard yolk (155° F. (68° C.) or greater core temperature). For cooked eggs 25 in the form of over easy and over hard, in embodiments the pasteurization tunnel 29 provides further cooking of the cooked eggs 25 in addition to pasteurization of the egg surfaces 92.

In embodiments, pasteurization lethality is validated by selection of residence time in the pasteurization tunnel 29, the temperature of the air, or heating medium such as steam, oil, or water within the tunnel, and the temperature of the upper surfaces 92 (FIG. 5) of the fried or otherwise cooked eggs 25 or egg mixtures 25′, and core temperatures of the egg yolks 86 or centers of egg mixtures in the cooking pans 38. In other embodiments, both pre- and post-egg cook inhibitors or sterilization options are employed, such as applications of spray-on soluble inhibitors added to the liquid egg 24 or liquid egg mixture 24′ after cracking or dispensing, respectively, or to the cooked egg 25 or cooked egg mixture 25′, or in other embodiments, during the cook fry by the induction heater 30.

Alternatively, or in addition to passing through the pasteurization tunnel 29 on cooking conveyor 28, the cooked eggs 25 or cooked egg mixtures 25′ are irradiated with ultraviolet (UV) light, for example, at a sterilization station 29A downstream of the pasteurization tunnel 29 for sterility of the surface 92. In still other embodiments, the system 100 includes an irradiation station 54A for application of electron beam irradiation of the cooked eggs 25 or cooked egg mixtures 25′ after they are packaged, as described below.

After the fried or otherwise cooked eggs 25 or egg mixtures 25′ pass through the pasteurization tunnel 29, and any other selected sterilization devices, such as a sterilization station 29A, which in embodiments is a UV sterilization station, the cooking and sterilization of the eggs 25 or egg mixtures 25′ is complete. The cooking conveyor 28 moves the cooking pans 38 from the raw area 12, through the separation wall 16 and into the ready-to-eat area 14. In the ready-to-eat area 14, the cooking conveyor 28 moves the cooking pans 38 carrying fried or otherwise cooked eggs 25 or egg mixtures 25′ into a freezer unit 52, where the fried or otherwise cooked eggs are frozen to 10° F. (−12° C.). At this point, the fried or otherwise cooked eggs 25 or egg mixtures 25′ will be hard and non-pliable.

The frozen fried or otherwise cooked eggs 25 or egg mixtures 25′ are now removed from their respective cooking pans 38. In embodiments, the removal of the fried or otherwise cooked eggs 25 or egg mixtures 25′ is effected using either a blast of filtered air or a slide that is incorporated into the freezer unit 52. The fried or otherwise cooked eggs 25 or egg mixtures 25′, removed from their respective cooking pans 38, are then loaded into a packaging machine 54, which in embodiments takes the form of a thermoforming packaging machine, that packages the fried or otherwise cooked eggs 25 or egg mixtures 25′ individually or in groups. FIG. 5 shows a sheet 82 divided into discrete pouches 80, each containing a fried or otherwise cooked egg 25 or egg mixture 25′. In an embodiment, the packaging machine seals, in embodiments vacuum seals, the fried or otherwise cooked egg product, in the form of a cooked egg 25 or cooked egg mixture 25′, in the pouches 80. In other embodiments, the cooked egg product, in the form of the fried or otherwise cooked eggs 25 or fried or otherwise cooked egg mixtures 25′ are first packaged, in embodiments vacuum sealed pouches 80, in the packaging machine 54, which incorporates the air blast or slide to remove the fried or otherwise cooked eggs 25 or egg mixtures 25′, then the packaged eggs 25 or egg mixtures 25′, which in embodiments are in sheets 82, are transported by the cooking conveyor 28 to the freezer unit 52 and frozen in package.

As shown in FIG. 5, the cooked eggs 25, or cooked egg mixture 25′, are sealed, in embodiments vacuum sealed, by the packaging machine 54 in individual pouches 80 that in embodiments are connected in a group, for example a group of 9 cooked eggs or cooked egg mixtures shown in FIG. 5. In embodiments, the group takes the form of a sheet 82 and the plastic material is sufficiently thick and stiff that the sheet retains its planar, or substantially planar, sheet shape and form to permit handling and stacking of sheets in the storage 70.

Packaging offers significant protection to the fried or otherwise cooked eggs 25 or egg mixtures 25′ and freezing maintains shelf life of the fried or otherwise cooked eggs or egg mixtures. Packaging materials are selected from rigid trays, formed rigid films, such as shown in FIG. 5, or semi-rigid materials, and all are FDA (Food and Drug Administration) approved for food contact. In embodiments, packaged frozen fried or otherwise cooked eggs 25 or egg mixtures 25′ will be gas flushed with straight nitrogen or a nitrogen and carbon dioxide mixture.

In other embodiments, the frozen fried or otherwise cooked eggs 25 or egg mixtures 25′ are sealed, in embodiments vacuum sealed, and the packaging machine 54 takes the form of a thermoforming packaging machine that forms trays of fried or otherwise cooked eggs 25 or egg mixtures 25′ such as tray or sheet 82 shown in FIG. 5 of fried or otherwise cooked eggs 25 in the sealed pouches 80. Packages or in embodiments pouches 80 of frozen fried or otherwise cooked eggs 25 or egg mixtures 25′ are sealed and in embodiments will maintain oxygen at or below 0.5% residual after leaving the packaging machine 54. In embodiments, the packaging films are selected to have oxygen and moisture barriers to further reduce the effects of oxidative spoilage. In embodiments, packages of frozen fried or otherwise cooked egg mixtures 25 or egg mixtures 25′ are placed within corrugated shippers (not shown) and labeled according to their customer specification.

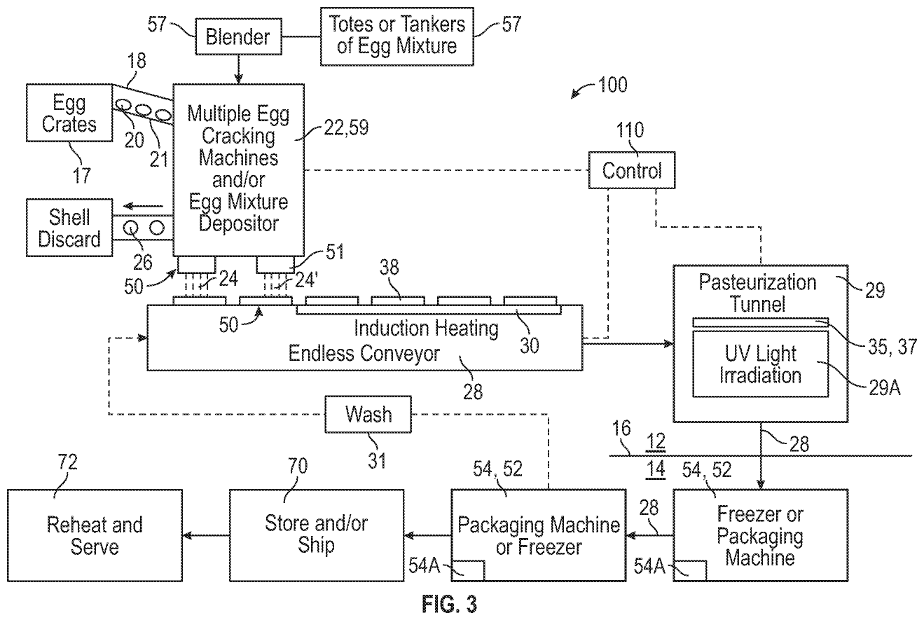

In an alternative embodiment, selected measured quantities of liquid egg mixture 24′ are deposited into the cooking pans 38 by the conduit 51 at the egg depositing location 50 (FIG. 3). In this embodiment, an egg mixture depositor 59 deposits liquid egg mixture 24′ onto the cooking pans 38 through conduit 51. In embodiments, the cooking pans 38 are selected to have peripheral shapes other than round, such as an eccentric shape. The liquid egg mixture 24′ undergoes a similar cooking, pasteurization, freezing, and packaging process to form a frozen, pasteurized cooked egg mixture 25′ as described herein for the cooked egg 25. Such a frozen egg product in the form of frozen, cooked egg mixture 25′, when reheated, delivers a unique, high protein egg-form snack, which may take the form of an omelet or frittata.

The resultant frying effect on the liquid eggs 24 and liquid egg mixtures 24′ from induction heating of the cooking pans 38 offers a flavor infusion from this cooking method that is unique to the market and differentiates these cooked eggs 25 and cooked egg mixtures 25′ from other cooked egg omelets, sandwich patties, and the like.

In embodiments, the packaged cooked eggs 25 and cooked egg mixtures 25′ are conveyed to a refrigerated storage 70. The packaged cooked eggs 25 and cooked egg mixtures 25′ are then reheated and served at a food service facility 72. The refrigerated storage 70 in embodiments is a freezer or a refrigerator, which is either on site at the food service facility 72, or is remote from it, or is located at the production facility as part of the ready-to-eat area 14.

In an embodiment of the system 100, the control 110 actuates and coordinates the operation of one or more of the infeed conveyors 18, egg cracking machine 22, cooking conveyor 28, induction heater 30, pasteurization tunnel 29, sterilization station 29A, spraying station 45, freezer unit 52, packaging machine 54, and irradiation station 54A. The control 110 in embodiments is a computer control, which may be part of a network, such as a control area network (CAN), local area network (LAN), or wide area network (WAN), and connected to the aforementioned components of the system 10 either by cable or wirelessly. In other embodiments, the control 110 is in the form of distributed intelligence, for example, a network of controls in one or more of the system components that may or may not be interconnected. In embodiments, the control 110 is programmed to control and coordinate the speed of the cooking conveyor 28, the temperature of induction heating of the cooking pans 38, and the dry and wet bulb temperatures in the pasteurization tunnel 29 to ensure that the cooked eggs 25 or cooked egg mixtures 25′ are thoroughly cooked, but not overcooked to achieve the desired egg product, such as sunny side up, over easy, or over hard fried eggs, and scrambled eggs, egg omelets, or frittatas.

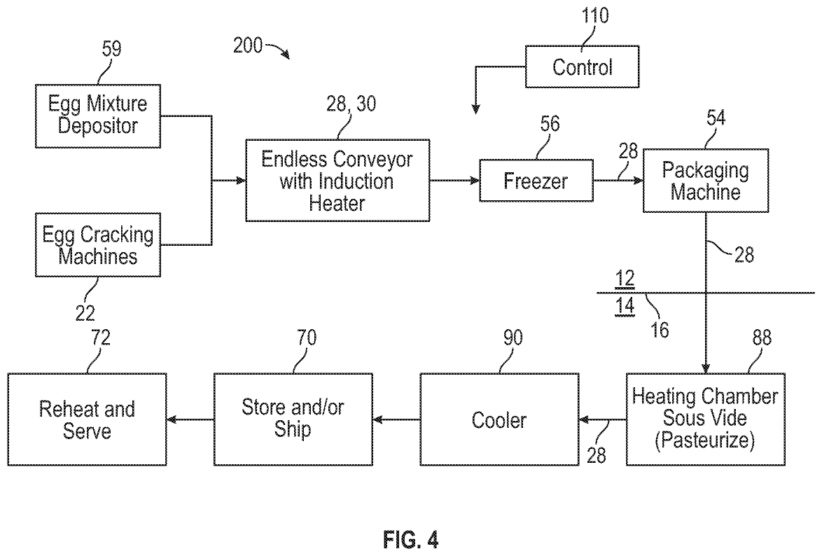

As shown in FIGS. 4 and 5, in another embodiment, a system for manufacturing a cooked egg product, in particular sunny side up cooked eggs 84, is generally designated 200. Many of the components of the system 100, shown for example in FIGS. 2 and 3, are incorporated in the system 200 and are designated with the same reference numbers. The system 200 includes one or more egg cracking machines 22 that receive whole raw eggs 20 from a conveyor 18 (FIG. 3). The egg cracking machines 22 deposit individual raw whole eggs 20 with intact yolks 86 onto cooking pans 38 mounted on a cooking conveyor 28 having a plurality of cooking pans.

In an embodiment, the egg cracking machine 22 deposits the liquid egg 24, which in the embodiment of FIGS. 4 and 5 is a plurality of shelled raw whole eggs 20 (FIG. 1), individually onto each of the plurality of cooking pans 38 on the cooking conveyor 28. The cooking conveyor 28 conveys the cooking pans 38 over the induction heater 30, which induction heats the cooking pans sufficiently to fry the liquid eggs 24 contained in the cooking pans to make sunny side up cooked eggs 25 (FIG. 5). In embodiments, at this point the sunny side up cooked eggs 25 are fully cooked sunny side up eggs having the desired doneness of the whites 93 and substantially liquid yolks 86, for example between 140° F. and 145° F. (60° C. and 63° C.). In an embodiment, the system 200 includes a spraying station 45 (FIG. 2) where a cooking oil or other release agent is sprayed onto the upper surface of the bottom walls 42 of the cooking pans 38 prior to the cooking pans receiving the liquid eggs 24.

The sunny side up cooked eggs 25, in embodiments fully cooked, are conveyed by the conveyor 28 to a freezer unit 52, resulting in frozen sunny side up cooked eggs. In an embodiment, the sunny side up cooked eggs 25 are frozen to about 10° F. (−12° C.) and transported by conveyor 28 to a packaging machine 54. In an embodiment, the packaging machine 54 receives the frozen sunny side up cooked eggs 25 and seals, in embodiments vacuum seals, the frozen sunny side up fully cooked eggs in plastic pouches 80 in a full or partial vacuum, which in embodiments are part of an array or sheet 82, as shown in FIG. 5. In an embodiment, the plastic comprising the sheet 82 is selected to be sufficiently stiff and rigid to minimize flexing and maintain a substantially planar shape, so that the sheets act as trays.

In embodiments, the conveyer 28 transports the sheets 82, comprised of plastic pouches 80 of frozen sunny side up cooked eggs 25, from the raw area 12 through the separation wall 16 to a to a heating chamber 88 in the ready-to-eat area 14. The heating chamber 88 sous vide heats the frozen sunny side up cooked eggs 25 for a time and temperature selected to pasteurize the upper surfaces 92 of the sunny side up cooked eggs sealed in their pouches 80, and in embodiments below a temperature at which the yolks of the cooked sunny side up eggs cook further and solidify, resulting in pasteurized sunny side up cooked eggs in the pouches. In an embodiment, the conveyor 28 transports the pasteurized sunny side up cooked eggs 25 in the pouches to a cooler 90 that chills or freezes the pasteurized sunny side up cooked eggs.

The chilled or frozen pasteurized sunny side up cooked eggs 25, still in trays or sheets 82 comprised of individual sealed pouches 80, each having a frozen or chilled pasteurized sunny side up cooked eggs, are then transported to storage 70, or are shipped to the end user, which may be a restaurant or other food service facility, such as an educational or institutional facility. In embodiments, the end user also may store the pasteurized sunny side up cooked eggs 25 either chilled or frozen. The pasteurized sunny side up cooked eggs 25 then can be reheated, such as by microwaving, oven heating, or sous vide heating, and served.

In embodiments, the heating chamber 88 is actuated by the control 110 to heat the frozen sunny side up cooked eggs 25 at a temperature at or below 145° F. (63° C.), resulting in the pasteurized sunny side up cooked eggs 84 in the pouches 80. In embodiments of the system 200, the heating chamber 88 is controlled by the controller 110 to heat the frozen sunny side up cooked eggs 25 for approximately 45 minutes, resulting in the pasteurized sunny side up cooked eggs 84 in the pouches 80.

In embodiments of the system 200, the heating chamber 88 is operated by the control 110 to heat the frozen sunny side up cooked eggs 25 until the upper surfaces 92 of the frozen sunny side up cooked eggs 25 reach a temperature of 130° F. (54° C.), and in other embodiments 135° F. (57° C.), but do not exceed 145° F. (63° C.) for approximately 45 minutes, resulting in the pasteurized sunny side up cooked eggs 84 in the pouches 80. In other embodiments of the system 200, the heating chamber 88 is operated by the control 110 to heat the frozen sunny side up cooked eggs 25 until the upper surfaces 92 turn white with a soft yolk (143° F. (62° C.) core temperature) for over easy cooked eggs; and over hard, characterized by a white top and bottom with a hard yolk (155° F. (68° C.) or greater core temperature). For over easy and over hard cooked eggs 25, the heating chamber 88 provides additional cooking of the eggs 25 in addition to pasteurization.

The heating chamber 88 sous vide heats the frozen sunny side up cooked eggs 25 in the pouches 80 for a selected time and at a selected temperature to achieve the desired pasteurized cooked egg product 25 (sunny side up, over easy, or over hard) in a medium selected from submerging the pouches of frozen sunny side up cooked eggs entirely in a hot water bath, moist air, and dry air. In embodiments, the rigid trays or sheets 82 of frozen sunny side up cooked eggs 25 are stacked in the heating chamber 88. If the medium is a hot water bath, the stack of rigid sheets 82 may be submerged in the bath, in which case the cooking conveyor 28 would end at the inlet of the heating chamber and the rigid sheets 82 transferred to the heating chamber.

In yet another embodiment of the system 200, a depositor 59 deposits selected quantities of liquid egg mixture 24′ into the cooking pans 38 on the cooking conveyor 28 (FIGS. 2 and 3). The cooking conveyor 28 transports the cooking pans 38 of liquid egg mixture 24′ over the induction heater 30, which heats the cooking pans to partially or fully cook the egg mixture. The cooking conveyor 28 transports the cooking pans 38 of cooked egg mixtures 25′ to the freezer 52, where the cooked egg mixtures are frozen, in embodiments to about 10° F. (−12° C.), and to packaging machine 54, which seals, and in embodiments vacuum seals, the frozen cooked egg mixtures 25′ in pouches 80.

The sheets 82 of pouches 80 containing cooked egg mixtures 25′ are transported by cooking conveyor 28 to the heating chamber 88, which pasteurizes the surfaces 92 of the cooked egg mixtures 25′, and optionally further cooks the cooked egg mixtures. The pasteurized fully cooked egg mixtures 25′ are then transported to the cooler 90 and chilled or frozen for storage. The sheets 82 of fully cooked egg mixtures 25′ in pouches 80 subsequently can be shipped and/or stored in storage 70, for reheating and serving 72.

Accordingly, in an embodiment, the method of operating the system 200 shown in FIGS. 4 and 5 begins by depositing liquid eggs 24 individually onto each of a plurality of cooking pans 38 (FIGS. 2 and 3). The induction heater 30 is activated by the control 110 to induction heat the cooking pans 38 sufficiently to fry the liquid eggs 24 contained in the cooking pans to make sunny side up cooked eggs. The sunny side up cooked eggs 25 are then frozen in the cooking pans 38, resulting in frozen sunny side up cooked eggs. The frozen sunny side up cooked eggs 25 are sealed, and in embodiments vacuum sealed, in pouches 80, which in embodiments are incorporated into sheets 82.

The pouches 80 are sous vide heated in a heating chamber 88 for a time and temperature selected to pasteurize the upper surfaces of the sunny side up cooked eggs but below a temperature at which the yolks 86 of the cooked sunny side up eggs 25 solidify, resulting in pasteurized sunny side up cooked eggs in the pouches. The pasteurized cooked sunny side up eggs 25 are chilled in the pouches 80 in a cooler 90. In an embodiment of the method of the system 200, the heating chamber 88 is controlled by the control 110 to heat at least the surfaces 92 of the frozen sunny side up cooked eggs 25 to a temperature at or below 145° F. (63° C.), resulting in the pasteurized sunny side up cooked eggs in the pouches 80. In other embodiments, wherein the heating chamber is actuated by the control 110 to heat the frozen sunny side up cooked eggs 25 for approximately 45 minutes, resulting in the pasteurized sunny side up cooked eggs in the pouches 80. In still other embodiments, of the system 200, the heating chamber 88 is actuated by the control 110 to heat the frozen sunny side up cooked eggs 25 until the upper surfaces 92 of the frozen sunny side up cooked eggs reach a temperature that reaches but does not exceed 145° F. (63° C.) for approximately 45 minutes, resulting in the pasteurized sunny side up cooked eggs in the pouches 80.

In embodiments of the method of the system 200, the heating chamber 88 is regulated by the control 110 to heat the frozen sunny side up cooked eggs 25 such that the core temperatures of yolks 86 of the eggs do not exceed 143° F. (62° C.), to avoid solidification of the yolks. In embodiments, the heating chamber 88 sous vide heats the frozen sunny side up cooked eggs 25 in a medium selected from submerging the pouches 80 of frozen sunny side up cooked eggs entirely in a hot water bath, moist air, and dry air. In embodiments, the heat energy supplied to the heating chamber 88 is by electric resistance heat, steam, or hot water.

The systems 100, 200 and methods are efficient at providing fully cooked eggs 25 and fully cooked egg mixtures 25′ that are pasteurized, and sealed, in embodiments vacuum sealed, in pouches 80 that can be stored indefinitely for use, and in commercial quantities. This is particularly useful for fast food and quick serve restaurants. The end user need only reheat the pouches to enjoy the taste of fried eggs or fried or cooked egg mixtures such as scrambled eggs, omelets, frittatas, and the like. The systems 100, 200 are adjustable to provide a variety of cooked eggs and egg products with little or no adjustment. The systems 100, 200 are particularly useful in producing sunny side up eggs, in which the sunny side up eggs are fried, frozen, vacuum sealed, and upper surfaces of the eggs are pasteurized in pouch without overcooking the yolks, so that the egg yolks remain liquid, or substantially liquid when the eggs are reheated.

While the forms of method and systems described herein constitute preferred embodiments of the subject method and system for manufacturing a cooked egg product, it is to be understood that the invention is not limited to these precise methods and systems, and that changes may be made therein without departing from the scope of the invention.

What is claimed is:

1. A system for manufacturing a cooked egg product, the system comprising:
an automated egg cracker that receives raw, shelled eggs and removing shells from the eggs;
a cooking conveyor having a plurality of cooking pans that receives the eggs from the automated egg cracker;
an induction heater that heats the cooking pans sufficiently to completely cook the eggs contained in the cooking pans, resulting in cooked eggs;
a pasteurization tunnel that receives the cooked eggs in the cooking pans from the induction heater; and
a control that actuates the pasteurization tunnel to heat upper surfaces of the cooked eggs to a pasteurization temperature, resulting in a cooked egg product of pasteurized cooked eggs;
a freezer unit that freezes the pasteurized cooked eggs, resulting in frozen pasteurized cooked eggs; and
a packaging machine that packages the pasteurized cooked eggs, resulting in packaged pasteurized cooked eggs.

2. The system of claim 1, wherein the pasteurization tunnel heats the cooked eggs in the cooking pans by one or more of steam heat and electric heat.

3. The system of claim 1, wherein the system pasteurizes the cooked eggs by one or more of steam heat, irradiation by ultraviolet light, and irradiation by electron beam of the packaged cooked eggs.

4. The system of claim 1, wherein the induction heater includes a plurality of induction coils, and the cooking conveyor passes the cooking pans over the induction coils.

5. The system of claim 1, further comprising a wash station that washes the cooking pans on the cooking conveyor.

6. The system of claim 1, further including a spraying station that sprays a non-stick lubricant or release agent onto upper surfaces of the cooking pans.

7. The system of claim 1, wherein the packaging machine includes an irradiation station that applies electron beam irradiation of the cooked egg product after packaging.

8. The system of claim 1, wherein the packaging machine is a thermoforming packaging machine.

9. The system of claim 1, wherein the pasteurization tunnel includes a heating unit selected from electric coils, steam coils, gas flame, and infrared coils.

10. The system of claim 9, wherein the pasteurization tunnel heats the cooked eggs by a method selected from direct heat, convection, direct steam injection in a pan, and a heated oil bath.

11. The system of claim 10, wherein the selected direct steam injection in the pan or the heated oil bath is below the cooking conveyor.

12. The system of claim 1, further comprising a control that maintains a wet bulb temperature within the pasteurization tunnel to between 130° F.-200° F. (54° C.-93° C.) to finish cooking the egg product in the cooking pans.

13. A system for manufacturing a cooked egg product, in particular sunny side up eggs, the system comprising:
a cooking conveyor having a plurality of cooking pans;
an egg cracking machine that deposits raw whole eggs individually onto each of the plurality of cooking pans;
an induction heater that heats the cooking pans sufficiently to fry the raw whole eggs contained in the cooking pans to make sunny side up cooked eggs;
a freezer that freezes the sunny side up cooked eggs, resulting in frozen sunny side up cooked eggs;
a packaging machine that receives the frozen sunny side up cooked eggs and vacuum seals the frozen sunny side up cooked eggs in pouches;
a heating chamber that receives the pouches of frozen sunny side up cooked eggs and sous vide heats the frozen sunny side up cooked eggs for a time and temperature selected to pasteurize upper surfaces of the sunny side up cooked eggs but below a temperature at which yolks of the cooked sunny side up eggs solidify, resulting in pasteurized sunny side up cooked eggs in the pouches; and
a cooler that chills or freezes the pasteurized cooked sunny side up eggs in the pouches, resulting in chilled or frozen pasteurized sunny side up eggs.

14. The system of claim 13, wherein the heating chamber is controlled to heat the frozen sunny side up cooked eggs at a temperature at or below 145° F. (63° C.), resulting in the pasteurized sunny side up cooked eggs in the pouches.

15. The system of claim 14, wherein the heating chamber is controlled to heat the frozen sunny side up cooked eggs for approximately 45 minutes, resulting in the pasteurized sunny side up cooked eggs in the pouches.

16. The system of claim 13, wherein the heating chamber is controlled to heat the frozen sunny side up cooked eggs until the upper surfaces of the frozen sunny side up cooked eggs reaches a temperature reaches but does not exceed 145° F. (63° C.) for approximately 45 minutes, resulting in the pasteurized sunny side up cooked eggs in the pouches.

17. The system of claim 13, wherein the heating chamber sous vide heats the frozen sunny side up cooked eggs in a medium selected from submerging the pouches of frozen sunny side up cooked eggs entirely in a hot water bath, moist air, and dry air.

18. A method for manufacturing a cooked egg product, the method comprising:
placing raw, shelled eggs on an infeed conveyor in a raw area;
receiving the raw, shelled eggs from the infeed conveyor and removing the shells from the eggs by an automatic egg cracker, resulting in liquid whole eggs;
receiving the liquid whole eggs from the automatic egg cracker and placing the liquid whole eggs on a plurality of cooking pans on a cooking conveyor that receives the liquid whole eggs from the automatic egg cracker;
induction heating the cooking pans sufficiently to cook the liquid whole eggs contained in the plurality of cooking pans, resulting in the cooked egg product in the form of cooked eggs;
receiving the cooking pans containing the cooked eggs in a pasteurization tunnel and pasteurizing the cooked eggs, resulting in pasteurized cooked eggs; and
receiving the pasteurized cooked eggs in a freezer in a ready-to-eat area and freezing and packaging the pasteurized cooked eggs.

19. The method of claim 18, wherein the pasteurized cooked eggs are first removed from their respective cooking pans, then frozen, then packaged.

20. The method of claim 18, wherein the pasteurized cooked eggs are first removed from their respective cooking pans, then packaged, then frozen.

21. A method for manufacturing a cooked egg product, in particular sunny side up eggs, the method comprising:
depositing raw whole eggs individually onto each of a plurality of cooking pans;
induction heating the cooking pans sufficiently to fry the raw whole eggs contained in the cooking pans to make sunny side up cooked eggs;
freezing the sunny side up cooked eggs in the cooking pans, resulting in frozen sunny side up cooked eggs;
vacuum sealing the frozen sunny side up cooked eggs in pouches;
sous vide heating the pouches of frozen sunny side up cooked eggs for a time and temperature selected to pasteurize upper surfaces of the sunny side up cooked eggs but below a temperature at which yolks of the cooked sunny side up eggs solidify, resulting in pasteurized sunny side up cooked eggs in the pouches; and
chilling or freezing the pasteurized cooked sunny side up eggs in the pouches.

22. The method of claim 21, wherein the sous vide heating is in a heating chamber controlled to heat the frozen sunny side up cooked eggs at a temperature at or below 145° F. (63° C.), resulting in the pasteurized sunny side up cooked eggs in the pouches.

23. The method of claim 21, wherein the sous vide heating is in a heating chamber controlled to heat the frozen sunny side up cooked eggs for approximately 45 minutes, resulting in the pasteurized sunny side up cooked eggs in the pouches.

24. The method of claim 23, wherein the heating chamber is controlled to heat the frozen sunny side up cooked eggs until the upper surfaces of the frozen sunny side up cooked eggs reaches a temperature reaches but does not exceed 145° F. (63° C.) for approximately 45 minutes, resulting in the pasteurized sunny side up cooked eggs in the pouches.

25. The method of claim 24, wherein the heating chamber is controlled to heat the frozen sunny side up cooked eggs such that a core temperature of yolks of the eggs does not exceed 143° F. (62° C.).

26. The system of claim 24, wherein the heating chamber sous vide heats the frozen sunny side up cooked eggs in a medium selected from submerging the pouches of frozen sunny side up cooked eggs entirely in a hot water bath, moist air, and dry air.
